(19) United States
(12) Patent Application Publication
(10) Pub. No.: US 2007/0130623 A1
(43) Pub. Date: Jun. 7, 2007

(54) Apparatus for generation of intrusion alert data and method thereof

(76) Inventors: Myung Eun Kim, Daejeon-city (KR); Dong Il Seo, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/507,268

(22) Filed: Aug. 21, 2006

(30) Foreign Application Priority Data
Dec. 1, 2005 (KR) 10-2005-0116584

(51) Int. Cl. G06F 12/14

(52) U.S. Cl. 726/23

(57) ABSTRACT

An apparatus for generating intrusion alert data and a method thereof are provided. The apparatus for generating and transmitting alert data in relation to intrusion includes: an input unit receiving inputs of an alert data type in preparation against an intrusion, and a transmission amount per unit time for transmitting the alert data; an intrusion alert data generation unit generating intrusion alert data according to the alert data type and the transmission amount per unit time; and an intrusion alert data transmission unit transmitting the generated intrusion alert data to a security management system at the rate of the transmission amount per unit time. By generating a large amount of intrusion alert data by using a variety of intrusion alert transfer protocols, and transmitting the data, the performance test of a function for processing intrusion alert data of a security management system can be performed efficiently.

### CROSS-REFERENCE TO RELATED PATENT APPLICATIONS

This application claims the benefit of Korean Patent Application No. 10-2005-0116584, filed on Dec. 1, 2005, in the Korean Intellectual Property Office, the disclosure of which is incorporated herein in its entirety by reference.

### BACKGROUND OF THE INVENTION

1. Field of the Invention

The present invention relates to security, and more particularly, to an intrusion alert data generation apparatus and method that can be used in a variety of application fields, including a performance test of processing intrusion alert data of a security management system.

2. Description of the Related Art

As a variety of network security devices have been developed, security management systems for managing the equipment also have been introduced in the market. This security management system collects intrusion alert data from network security devices installed in a network domain that the security management system is managing, and performs security monitoring of the entire network.

The security management system collects and analyzes intrusion alert data from security devices installed in the network, determines the security level of the network, and manages the network. In particular, when attacks are proceeding across a plurality of network domains as by a denial of service (DoS) and/or distributed denial of services (DDoS), the attacks can be detected and handled more effectively by the security management system.

Recently, in line with the development of network technologies, the performance of the networks has been rapidly increasing. Accordingly, network security devices have also been being developed in the form of hardware devices in order to process a huge amount of traffic. As a result, the security management system collecting intrusion alert data from the network security devices have also been developed with a higher performance in response to the higher performance of the network security devices.

Currently, high performance network security devices products implemented as hardware solutions are flooding in the network security equipment market, filling the most part of the market, but the development of a high performance security management system is still insignificant.

Development of a system technology enabling quick generation and transmission of a large amount of intrusion alert data for development of a high performance security management system product and for performance test of the product will soon be required, and there have been no appropriate solutions in that category.

### SUMMARY OF THE INVENTION

The present invention provides an intrusion alert data generation apparatus and method that can be used in a variety of application fields, including a performance test of processing intrusion alert data of a security management system.

According to an aspect of the present invention, there is provided an intrusion alert data generation apparatus for generating and transmitting alert data in relation to intrusion, the apparatus including: an input unit receiving inputs of an alert data type in preparation against an intrusion, and a transmission amount per unit time for transmitting the alert data; an intrusion alert data generation unit generating intrusion alert data according to the alert data type and the transmission amount per unit time; and an intrusion alert data transmission unit transmitting the generated intrusion alert data to a predetermined security management system at the rate of the transmission amount per unit time.

The type of a protocol to be used in transferring intrusion alert data may be input together through the input unit, and when intrusion alert data is generated, the intrusion alert data generation unit may generate intrusion alert data by considering the type of the protocol for transferring the intrusion alert data, and the intrusion alert data transmission unit may transmit the intrusion alert data according to the protocol.

According to another aspect of the present invention, there is provided an intrusion alert data generation method of generating and transmitting alert data in relation to intrusion, the method including: receiving inputs of an alert data type in preparation against an intrusion, alert data according to the type, and a transmission amount per unit time for transmitting the alert data; generating intrusion alert data according to the alert data type and the transmission amount per unit time; and transmitting the generated intrusion alert data to a predetermined security management system at the rate of the transmission amount per unit time.

In the receiving of the inputs, if the type of a protocol to be used in transferring intrusion alert data is input together, in the generating of the intrusion alert data, the intrusion alert data may be generated by considering the type of the protocol for transferring the intrusion alert data, and in the transmitting of the generated intrusion alert data, the intrusion alert data may be transmitted according to the input protocol.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of an intrusion alert data generation apparatus according to an embodiment of the present invention;

FIG. 2 is a flowchart of an intrusion alert data generation method according to an embodiment of the present invention;

FIG. 3 illustrates a detailed structure an intrusion alert data generation apparatus according to an embodiment of the present invention; and

FIG. 4 is a detailed flowchart of an intrusion alert data generation method according to an embodiment of the present invention.

### DETAILED DESCRIPTION OF THE INVENTION

The present invention will now be described more fully with reference to the accompanying drawings, in which exemplary embodiments of the invention are shown.

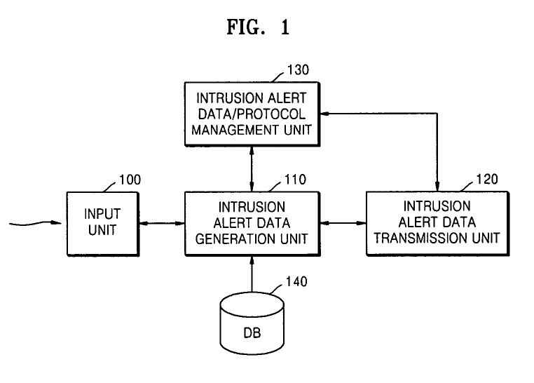

FIG. 1 illustrates a structure of an intrusion alert data generation apparatus according to an embodiment of the present invention.

This apparatus for generating and transmitting alert data in relation to intrusion includes an input unit 100 receiving inputs of an alert data type in preparation against an intrusion, and a transmission amount per unit time for transmitting the alert data, an intrusion alert data generation unit 110 generating intrusion alert data according to the alert data type and the transmission amount per unit time and an intrusion alert data transmission unit 120 transmitting the generated intrusion alert data to a predetermined security management system at the rate of the transmission amount per unit time.

Also, the apparatus further includes an intrusion alert data/protocol management unit 130 monitoring and reporting the state of transmitting intrusion alert data, and an intrusion alert transfer data format database 140 storing information on predetermined formats of intrusion alert data.

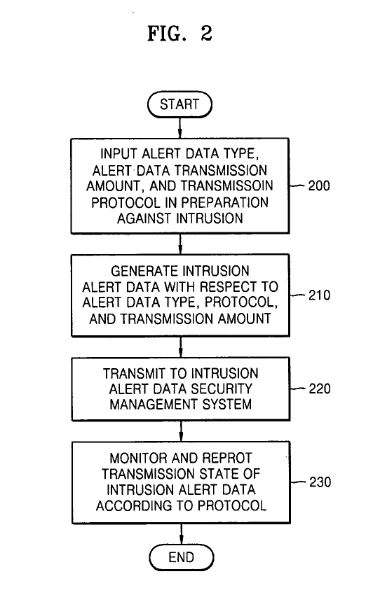

FIG. 2 is a flowchart of an intrusion alert data generation method according to an embodiment of the present invention.

This method of generating and transmitting alert data in relation to intrusion includes receiving inputs of an alert data type in preparation against an intrusion, and a transmission amount per unit time for transmitting the alert data in operation 200, generating intrusion alert data according to the alert data type and the transmission amount per unit time in operation 210, transmitting the generated intrusion alert data to a predetermined security management system at the rate of the transmission amount per unit time in operation 220, and monitoring and reporting the state of transmitting the intrusion alert data according to a protocol used in transferring the intrusion alert in operation 230.

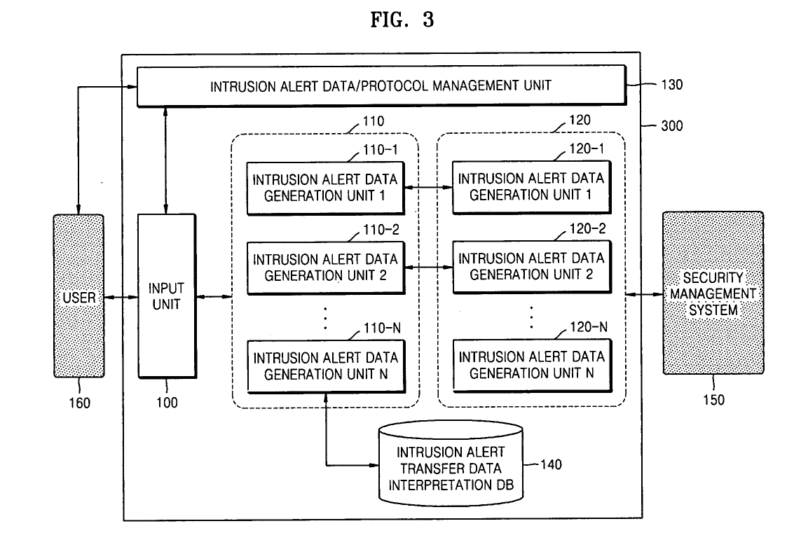

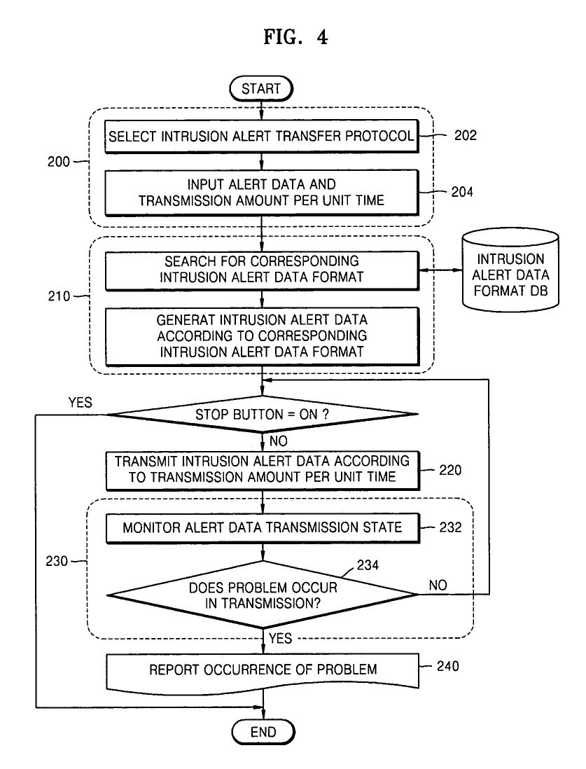

The embodiments of FIGS. 1 and 2 will be explained together with FIGS. 3 and 4 showing more detailed examples.

FIG. 3 illustrates a detailed structure an intrusion alert data generation apparatus according to an embodiment of the present invention. The apparatus has the same structure as that of FIG. 1, and shows more details of the inside of each block. The same reference number as that of FIG. 1 indicates an identical unit.

A user 160 inputs an alert data type in preparation against an intrusion, and a transmission amount per unit time for transmitting the alert data through the input unit 100. Also, the type of a protocol to be used in transferring intrusion alert data is input together through the input unit 100 in operation 200. Accordingly, the intrusion alert data in relation to the protocol and the transmission amount per unit time of the alert data are input according to the type of the protocol.

This process is to input basic information to generate intrusion alert data, and based on this basic information, intrusion alert data is generated.

The data input through the input unit is transferred to the intrusion alert data generation unit 110. The intrusion alert data generation unit 110 generates intrusion data according to the information input by the user in operation 210.

At this time, if the user specifies a protocol to be used for transmission, one of intrusion alert data generation units 110-1 through 110-N of FIG. 3 in relation to each protocol is determined, and the intrusion alert data generation unit generates intrusion alert data according to the protocol. If the transmission rate per time unit is high, the amount of data corresponding to the transmission rate is generated.

In the intrusion alert transfer protocol database 140 information on data formats to generate intrusion alert data in relation to each protocol that can be used for data transmission is stored in advance. An intrusion alert data generation unit 110 or any one of 110-1 through 110-N that desires to generate intrusion alert data searches the intrusion alert transfer protocol database 140 for the format of intrusion alert data corresponding to the protocol input by the user through the input unit 100, and according to the found data format, generates intrusion alert data.

The intrusion alert data transmission unit 120 receives intrusion alert data transferred by any corresponding one of intrusion alert data generation units 1 through N 110-1 through 110-N in the intrusion alert data generation unit 110, and transmits the data to the security management system 150 in operation 220.

The intrusion alert data transmission unit 120 includes intrusion alert data transmission unit 1 through N 120-1 through 120-N, each of the intrusion alert data transmission unit 1 through N 120-1 through 120-N, receives any corresponding one of intrusion alert data generation units 1 through N 110-1 through 110-N and transmits the intrusion alert data to the security management system 160.

In an embodiment, data generation and transmission unit dedicated for each protocol as shown in FIG. 3 can be included in the implementation. Also, in another embodiment, data may be generated separately for each protocol and then transmission may be performed by one transmission unit.

In particular, when the structure of FIG. 3 is implemented in an entire network or in a large-sized network combining a plurality of networks, if a pair of an intrusion alert data generation unit and an intrusion alert data transmission unit are made to be in charge of a small-sized network, for example, the intrusion alert data generation unit 1 and the intrusion alert data transmission unit 1, are made to be in charge of one network, and other pairs are made to be in charge of other networks, the structure of FIG. 3 according to the present invention can also be applied to the large-sized network.

The intrusion alert data by the intrusion alert data transmission unit 120 is transmitted at the rate of the transmission amount per unit time which was inputted by the user in operation 200. The transmission rate may be determined per hour, per minute, or per second. The data transmitted by the intrusion alert data transmission unit 120 is transmitted according to the protocol input by the user.

The intrusion alert data/protocol management unit 130 manages and monitors the state of transmitting the intrusion alert data according to the protocol used for the transfer of intrusion alert, and reports the result to the user 160 or an administrator. Through this process, the user 160 or administrator can manage the process of transmitting and testing the intrusion alert.

FIG. 4 is a detailed flowchart of an intrusion alert data generation method according to an embodiment of the present invention. This is a detailed example of FIG. 2. Likewise, an identical reference number indicates the same operation as in FIG. 2.

If an intrusion alert transfer protocol, intrusion alert data, and a transmission amount per unit time are input by the user in operations 202 and 204, the format of the intrusion alert data according to the protocol is determined by searching an intrusion alert data format database, and according to the format, intrusion alert data is generated in operation 210.

If a test using intrusion alert data prepared according to the present invention is not proceeding by the administrator or user, and if a test stop button is pressed, the test is finished immediately. Unless the stop button is pressed, the present invention is continuously executed and according to the transmission amount per unit time input in operation 204, intrusion alert data is transmitted in operation 220.

The intrusion alert data/protocol management unit 130 monitors the state of transmitting intrusion alert data in operation 230. That is, it is monitored whether or not the transmission protocol, the transmission amount and the type of data being transmitted are the same as specified by the user.

While monitoring the state of transmitting intrusion alert data in operation 232, it is continuously determined whether or not a problem occurs during the transmission in operation 234. If no problem occurs, operation 220 is performed again continuously. In this case, unless a problem occurs or the stop button is pressed by the user, the monitoring operation continues.

The occurrence of a problem during transmission indicate that any one of the transmission protocol, the transmission amount and the type of data transmitted specified by the user is not maintained, and in addition, may also indicate that a problem occurs due to an external cause during the transmission.

If a problem occurs during the transmission, the intrusion alert data/protocol management unit 130 reports the occurrence of the problem to the user in operation 240 and finishes the process.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation.

For example, the Internet may be used as the network described above, but a public telephone network, such as a public switched telephone network (PSTN), may also be used.

Therefore, the scope of the invention is defined not by the detailed description of the invention but by the appended claims, and all differences within the scope will be construed as being included in the present invention.

Also, it is easily understood by those skilled in the art that each step of the present invention can be implemented in a variety of ways, including by software using a general programming technique, and by hardware.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, the apparatus for generating and transmitting alert data in relation to intrusion includes an input unit receiving inputs of an alert data type in preparation against an intrusion, and a transmission amount per unit time for transmitting the alert data; an intrusion alert data generation unit generating intrusion alert data according to the alert data type and the transmission amount per time; and an intrusion alert data transmission unit transmitting the generated intrusion alert data to a security management system at the transmission rate per time.

By generating a large amount of intrusion alert data by using a variety of intrusion alert transfer protocols, and transmitting the data, the performance test of a function for processing intrusion alert data of a security management system can be performed efficiently.

What is claimed is:

1. An intrusion alert data generation apparatus for generating and transmitting alert data in relation to intrusion, the apparatus comprising:
an input unit receiving inputs of an alert data type in preparation against an intrusion, and a transmission amount per unit time for transmitting the alert data;
an intrusion alert data generation unit generating intrusion alert data according to the alert data type and the transmission amount per unit time; and
an intrusion alert data transmission unit transmitting the generated intrusion alert data to a predetermined security management system at the rate of the transmission amount per unit time.

2. The apparatus of claim 1, wherein the type of a protocol to be used in transferring intrusion alert data is input together through the input unit, and
when intrusion alert data is generated, the intrusion alert data generation unit generates intrusion alert data by considering the type of the protocol for transferring the intrusion alert data, and the intrusion alert data transmission unit transmits the intrusion alert data according to the protocol.

3. The apparatus of claim 1, further comprising an intrusion alert data/protocol management unit monitoring and reporting the state of transmitting intrusion alert data according to the protocol used for transferring the intrusion alert.

4. The apparatus of claim 1, further comprising an intrusion alert transfer data format database storing information on predetermined formats of intrusion alert data according to the type of a protocol to be used for transferring the intrusion alert,
wherein the intrusion alert data generation unit generates intrusion alert data according to a data format stored in the intrusion alert transfer protocol database.

5. An intrusion alert data generation method of generating and transmitting alert data in relation to intrusion, the method comprising:
receiving inputs of an alert data type in preparation against an intrusion, alert data according to the type, and a transmission amount per unit time for transmitting the alert data;
generating intrusion alert data according to the alert data type and the transmission amount per unit time; and
transmitting the generated intrusion alert data to a predetermined security management system at the rate of the transmission amount per unit time.

6. The method of claim 5, wherein in the receiving of the inputs, if the type of a protocol to be used in transferring intrusion alert data is input together,
in the generating of the intrusion alert data, the intrusion alert data is generated by considering the type of the protocol for transferring the intrusion alert data, and
in the transmitting of the generated intrusion alert data, the intrusion alert data is transmitted according to the input protocol.

7. The method of claim 5, further comprising monitoring and reporting the state of transmitting the intrusion alert data according to the protocol used in transferring the intrusion alert.

8. The method of claim 6, wherein in the transmitting of the generated intrusion alert data, if a problem occurs, transmission of the data is stopped and the problem is reported, and if no problem occurs, the generated alert data is continuously transmitted.
